(19) United States
(12) Patent Application Publication
(10) Pub. No.: US 2015/0185594 A1
(43) Pub. Date: Jul. 2, 2015

(54) DUSTPROOF COVER OF PROJECTOR

(71) Applicants: Jung-Chi Chen, Hsin-Chu (TW); Sheng-Yu Chiu, Hsin-Chu (TW); Chih-Hui Chang, Hsin-Chu (TW); Hsiu-Min Hsiao, Hsin-Chu (TW)

(72) Inventors: Jung-Chi Chen, Hsin-Chu (TW); Sheng-Yu Chiu, Hsin-Chu (TW); Chih-Hui Chang, Hsin-Chu (TW); Hsiu-Min Hsiao, Hsin-Chu (TW)

(73) Assignee: CORETRONIC CORPORATION, Hsin-Chu (TW)

(21) Appl. No.: 14/474,310

(22) Filed: Sep. 2, 2014

(30) Foreign Application Priority Data
Dec. 26, 2013 (CN) 201310730654.5

(51) Int. Cl. G03B 21/14; G03B 21/16

(52) U.S. Cl. CPC G03B 21/145; G03B 21/16

(57) ABSTRACT

A dustproof cover used in a projector has a casing and a projection lens, the projection lens is disposed at a front side of the casing, the projection lens has a first adjusting device disposed at a top side of the casing connected to front side. The dustproof cover includes a body, a lid, a transparent plate and at least one airtight trim, in which the body is assembled to the casing to cover the projection lens and the first adjusting device and has a first adjusting hole to expose the first adjusting device. The lid is detachably connected to the body to conceal the first adjusting hole. The transparent plate is disposed on the body to allow an image beam emitted from the projection lens passing through. The at least one airtight trim is connected to a portion of the casing contacted the body.

### CROSS-REFERENCE TO RELATED APPLICATION

This application claims the priority benefit of China application serial no. 201310730654.5, filed on Dec. 26, 2013. The entirety of the above-mentioned patent application is hereby incorporated by reference herein and made a part of this specification.

### BACKGROUND OF THE INVENTION

1. Field of the Invention

The invention generally relates to a projector, and more particularly, to a dustproof cover used in a projector.

2. Description of Related Art

A projector needs to use a high luminance light source, such as a high pressure mercury lamp or a light emitting diode (LED) lamp for operation, but the high luminance light source will accordingly generate a lot of heat. The huge heat generated by the light source must be in time removed to ensure the proper operation of the projector. In the related art of the projector, the heat is usually expelled in thermal convection way, so that the casing of a projector usually has a lot of air holes for hot and cold air to be in and out. However, it is also easy to deposit the outer dust into the projector to affect the regular operation of the projector. Therefore, many solutions for dustproof of the air holes have been proposed.

In addition, the projection lens is usually equipped with one or two adjusting rings which are locally exposed out of the casing of the projector so that a user can manually perform focusing or zooming operation. However, there is gaps usually existed between the casing of the projector and the aforementioned adjusting rings to tolerate the tolerances of the parts. Thus, at the time, the outer dust may enter the projector via the aforementioned gaps to affect the regular operation of the projector.

U.S. Patent Application Publication No. 20090201470 discloses a projection image display device having a dustproof design. U.S. Patent Application Publication No. 20060164609 also discloses a projector with a dustproof design.

### SUMMARY OF THE INVENTION

Accordingly, the invention is directed to a dustproof cover used in a projector to prevent dust from entering the casing via the gap between the casing of the projector and the adjusting device of the projection lens.

Other advantages of the invention should be further indicated by the disclosures of the invention, and omitted herein for simplicity.

To achieve one of, a part of or all of the above-mentioned objectives, or to achieve other objectives, an embodiment of the invention provides a dustproof cover, used in a projector, in which the projector has a casing and a projection lens, the projection lens is disposed at a front side of the casing, the projection lens has a first adjusting device disposed at a top side of the casing connected to the front side. The dustproof cover includes a body, a lid, a transparent plate and at least one airtight trim, wherein the body is assembled to the casing to cover the projection lens and the first adjusting device, and has a first adjusting hole to expose the first adjusting device. The lid is detachably connected to the body to conceal the first adjusting hole. The transparent plate is disposed on the body to allow an image beam emitted from the projection lens passing through. The at least one airtight trim is connected to a portion of the casing contacted the body.

In an embodiment of the invention, the projection lens has a second adjusting device disposed at the top side of the casing of the projector, the body has a second adjusting hole to expose the second adjusting device, and the lid conceals the second adjusting hole.

In an embodiment of the invention, the body has a fastening portion fastened to the casing of the projector.

In an embodiment of the invention, the lid is latched with the body.

In an embodiment of the invention, the body has a top portion, a rear frame and a front frame, the top portion covers the top side of the casing and forms the first adjusting hole, the rear frame extends to the front side of the casing from the top portion, the front frame is connected to the rear frame, and the transparent plate is disposed between the rear frame portion and the front frame portion.

In an embodiment of the invention, the transparent plate is adhered to the rear frame or the front frame, and the image beam emitted from the projection lens sequentially passes through the rear frame, the transparent plate and the front frame.

In an embodiment of the invention, an upper edge of the front frame is latched with an upper edge of the rear frame, and a lower edge of the front frame is fastened to a lower edge of the rear frame.

In an embodiment of the invention, the front frame has a front latching portion and a front fastening portion, the rear frame has a rear latching portion and a rear fastening portion, the front latching portion is coupled to the rear latching portion, and the front fastening portion is fastened to the rear fastening portion.

In an embodiment of the invention, the transparent plate is a glass plate.

In an embodiment of the invention, the transparent plate includes a glass plate and a wear layer disposed on an outer surface of the glass plate.

Based on the depiction above, the above embodiments of the invention can achieve at least one of the following advantages or efficiencies. In the aforementioned embodiment of the invention, when the dustproof cover is assembled to the casing of the projector, the dustproof cover can prevent dust from entering into the casing via the gap between the casing of the projector and the adjusting device of the projection lens. In addition, in the aforementioned embodiment of the invention, since the image beam emitted from the projection lens of the projector can pass through the transparent plate of the dustproof cover, so that the dustproof cover can keep providing the dustproof function whether the projector is running or not.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

In order to make the features and advantages of the invention more comprehensible, the invention is further described in detail in the following with reference to the embodiments and the accompanying drawings.

FIG. 1 is a three-dimensional diagram showing a dustproof cover and a projector the dustproof cover is to be assembled to according to an embodiment of the invention.

FIG. 2 is a three-dimensional diagram showing the dustproof cover has attached on the projector.

FIG. 3 is a three-dimensional diagram of the dustproof cover of FIG. 2 while a user is adjusting the projection lens.

FIG. 4 is an exploded diagram of the dustproof cover of FIG. 1.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between

“A” component and “B” component. Accordingly, the drawings and descriptions will be regarded as illustrative in nature and not as restrictive.

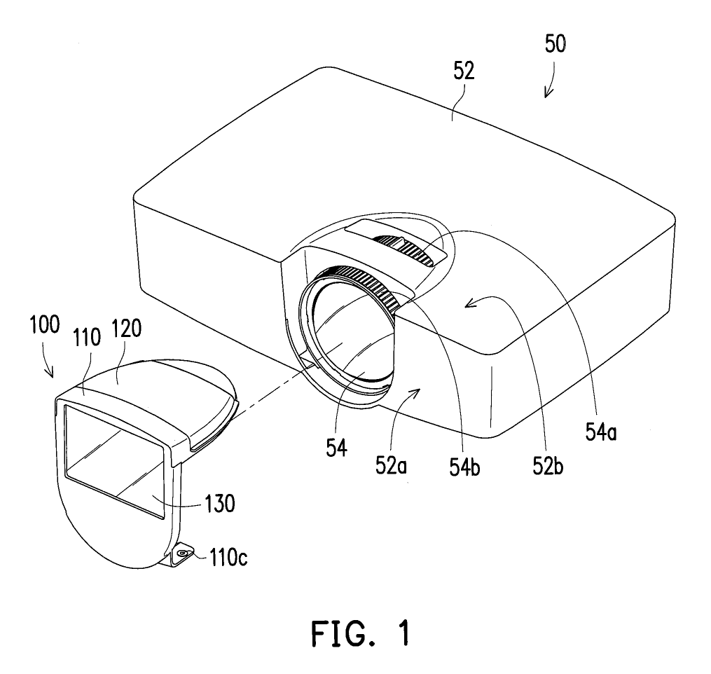

Referring to FIG. 1, a dustproof cover 100 of the embodiment can be applied in a projector 50. The projector 50 has a casing 52 and a projection lens 54. The projection lens 54 is disposed at a front side 52a of the casing 52. The projection lens 54 has a first adjusting device 54a disposed at a top side 52b of the casing 52 connected to the front side 52a. The dustproof cover 100 is assembled to the casing 52 of the projector 50. Specifically, the dustproof cover 100 can be attached to the casing 52 and cover the projection lens 54 and the first adjusting device 54a (for example, an adjusting ring). In the embodiment, the projection lens 54 further has a second adjusting device 54b (for example, an adjusting ring), and the dustproof cover 100 also covers the second adjusting device 54b. The user in the embodiment can manually adjust the first adjusting device 54a and the second adjusting device 54b to focus (adjusting the clarity of images) or zoom (adjusting the size of images). The first adjusting device 54a can be, for example, a focusing ring, and the second adjusting device 54b can be, for example, a zooming ring, however, the invention is not limited to.

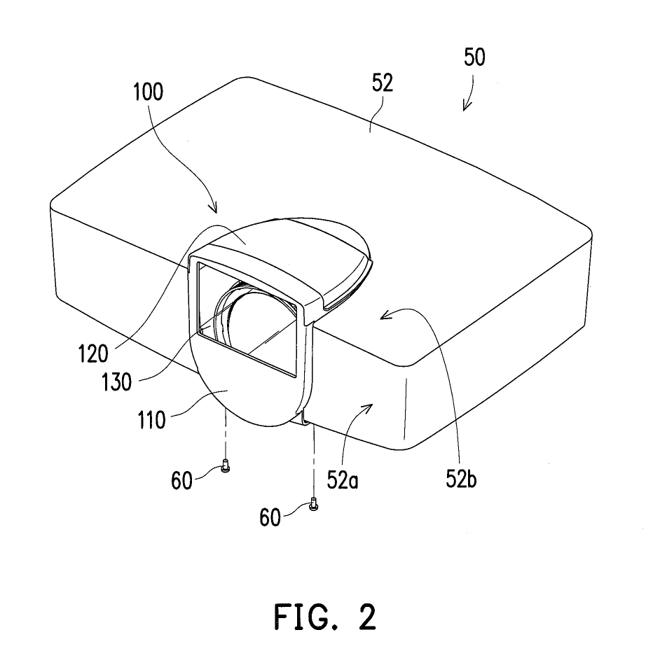

Referring to FIG. 2, when the dustproof cover 100 attaches on the casing 52, a plurality of fasteners 60 (for example, screws) can be used to fasten the dustproof cover 100 to the casing 52 of the projector 50. After fastening the dustproof cover 100 to the projector 50, the dustproof cover 100 can prevent dust from entering the casing 52 via the gap between the casing 52 and the adjusting device 54a (as shown by FIG. 1). The dustproof cover 100 includes a body 110, a lid 120 and a transparent plate 130. The lid 120 is detachably connected to the body 110, and the transparent plate 130 is disposed on the body 110 to allow the image beam emitted from the projection lens 54 passing through. In the embodiment, the elasticity of the lid 120 itself enables the two sides of the lid 120 respectively latched with the two sides of the body 110 so as to make the lid 120 temporarily (i.e., detachably) fixed on the body 110. In the embodiment, the body 110 has a plurality of fastening portions 110c (for example, thread hole), and the fastening portions 110c of the body 110 are fastened to the casing 52 of the projector 50 through the fasteners 60 (for example, screws). In addition, the transparent plate 130 includes a glass plate with a wear layer formed on the outer surface of the glass plate thereof to provide wear resistance.

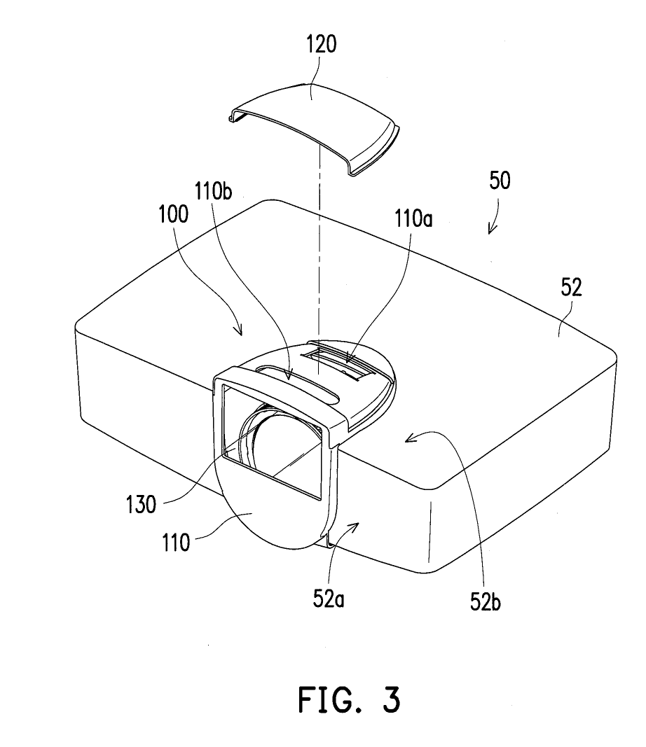

Referring to FIGS. 1 and 3, the lid 120 is detached from the body 110 in order to manually adjust the first adjusting device 54a and the second adjusting device 54b. The body 110 has a first adjusting hole 110a and a second adjusting hole 110b respectively exposing the first adjusting device 54a and the second adjusting device 54b. Thus, the user can adjust the first adjusting device 54a and the second adjusting device 54b by putting the finger thereof passing through the first adjusting hole 110a and the second adjusting hole 110b respectively. After the adjusting process described above, the user can latch the lid 120 with the body 110 again to conceal the first adjusting hole 110a and the second adjusting hole 110b so as to resume the dustproof function. In another embodiment, the projector 50 can have only the first adjusting device 54a without the second adjusting device 54b to provide the focusing function or zooming function, thus, the body 110 has only the first adjusting hole 110a without the second adjusting hole 110b. In yet another embodiment, the body 110 can have only the first adjusting hole 110a without the second adjusting hole 110b, wherein the first adjusting hole 110a can expose both the first adjusting device 54a and the second adjusting device 54b.

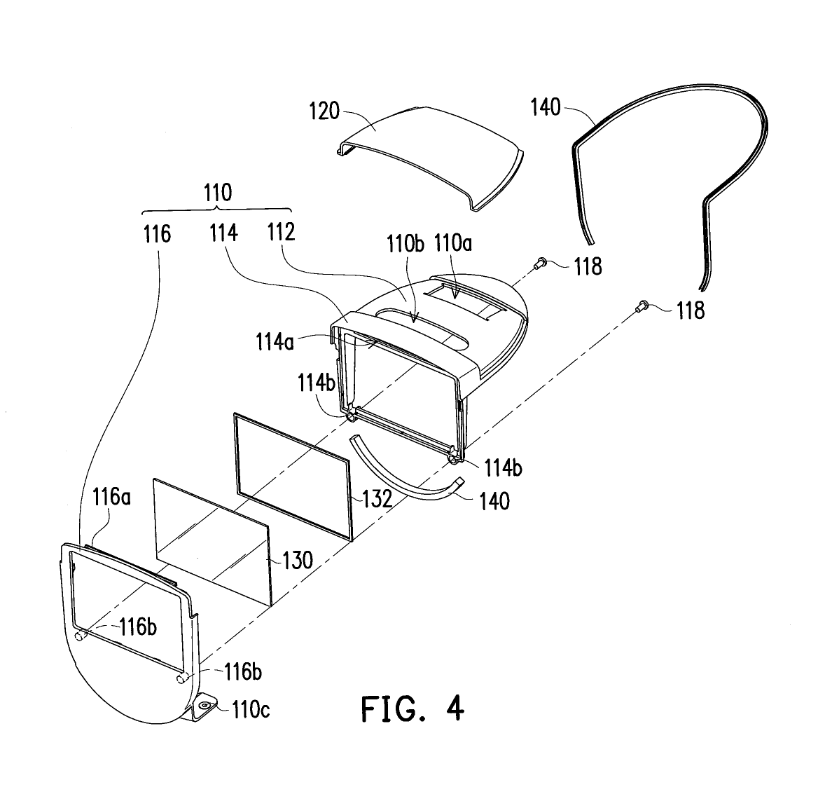

Referring to FIGS. 1 and 4, the dustproof cover 100 can further include a plurality of airtight trims 140 to block the outer dust, wherein the airtight trims 140 connected to a portion of the casing 52 contacted the body 110. In another embodiment, there is only one airtight trim 140 connected to a portion of the casing 52 contacted the body 110. The airtight trims 140 are made of rubber or foam, for instance, however, the invention is not limited thereto. In the embodiment, the body 110 has a top portion 112, a rear frame 114 and a front frame 116. The top portion 112 covers the top side 52b of the casing 52 and forms the first adjusting hole 110a. The rear frame 114 extends to the front side 52a of the casing 52 from the top portion 112. The front frame 116 is connected to the rear frame 114, wherein the transparent plate 130 is disposed between the rear frame 114 and the front frame 116. In the embodiment, the top portion 112 and the rear frame 114 are formed of a single part (for example, a plastic injecting part), and the front frame 116 is formed of another single part (for example, another plastic injecting part), however, the invention is not limited thereto. In addition, the transparent plate 130 is adhered to the rear frame 114 or the front frame 116 through adhesive 132 (such as a lap of double-sided adhesive tape), and the image beam emitted from the projection lens 54 sequentially passes through the rear frame 114, the transparent plate 130 and the front frame 116. The aforementioned fastening portions 110c can be formed on the front frame 116.

Referring to FIG. 4 again, an upper edge of the front frame 116 is latched with an upper edge of the rear frame 114 and a lower edge of the front frame 116 is fastened to a lower edge of the rear frame 114. Specifically, the front frame 116 has a front latching portion 116a (for example, hook) and a plurality of front fastening portions 116b, the rear frame 114 has a rear latching portion 114a (for example, locking slot) and a plurality of rear fastening portions 114b. The front latching portion 116a is coupled to the rear latching portion 114a, and the front fastening portions 116b are respectively fastened at the rear fastening portions 114b through a plurality of fasteners 118 (for example, screws). Thus, the transparent plate 130 can be sandwiched definitely between the rear frame 114 and the front frame 116.

In summary, the above embodiments of the invention can achieve at least one of the following advantages or efficiencies. In the above embodiments of the invention, the dustproof cover can prevent dust from entering the casing via the gap between the casing of the projector and the adjusting device of the projection lens when the dustproof cover is assembled to the casing of the projector. In addition, in the aforementioned embodiment of the invention, since the image beam emitted from the projection lens of the projector can pass through the transparent plate of the dustproof cover, so that the dustproof cover can keep providing the dustproof function whether the projector is running or not.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Moreover, these claims may refer to use “first”, “second”, etc. following with noun or element. Such terms should be understood as a nomenclature and should not be construed as giving the limitation on the number of the elements modified by such nomenclature unless specific number has been given.

What is claimed is:

1. A dustproof cover suitable for a projector, wherein the projector includes a casing and a projection lens, the projection lens is disposed at a front side of the casing, the projection lens has a first adjusting device disposed at a top side of the casing connected to front side, and the dustproof cover comprises:
a body assembled to the casing to cover the projection lens and the first adjusting device, wherein the body has a first adjusting hole to expose the first adjusting device;
a lid detachably connected to the body to conceal the first adjusting hole;
a transparent plate disposed on the body to allow an image beam emitted from the projection lens passing through; and
at least one airtight trim connected to a portion of the casing contacted the body.

2. The dustproof cover as claimed in claim 1, wherein the projection lens has a second adjusting device disposed at the top side of the casing of the projector, the body has a second adjusting hole to expose the second adjusting device, and the lid conceals the second adjusting hole.

3. The dustproof cover as claimed in claim 1, wherein the body has a fastening portion fastened to the casing of the projector.

4. The dustproof cover as claimed in claim 1, wherein the lid is latched with the body.

5. The dustproof cover as claimed in claim 1, wherein the body has a top portion, a rear frame and a front frame, the top portion covers the top side of the casing and forms the first adjusting hole, the rear frame extends to the front side of the casing from the top portion, the front frame is connected to the rear frame, and the transparent plate is disposed between the rear frame and the front frame.

6. The dustproof cover as claimed in claim 5, wherein the transparent plate is adhered to the rear frame or the front frame, and the image beam emitted from the projection lens sequentially passes through the rear frame, the transparent plate and the front frame.

7. The dustproof cover as claimed in claim 5, wherein an upper edge of the front frame is latched with an upper edge of the rear frame, and a lower edge of the front frame is fastened to a lower edge of the rear frame.

8. The dustproof cover as claimed in claim 5, wherein the front frame has a front latching portion and a front fastening portion, the rear frame has a rear latching portion and a rear fastening portion, the front latching portion is coupled to the rear latching portion, and the front fastening portion is fastened to the rear fastening portion.

9. The dustproof cover as claimed in claim 1, wherein the transparent plate is a glass plate.

10. The dustproof cover as claimed in claim 1, wherein the transparent plate comprises a glass plate and a wear layer, and the wear resistant layer is disposed on an outer surface of the glass plate.
